(19) United States
(12) Patent Application Publication
(10) Pub. No.: US 2013/0187837 A1
(43) Pub. Date: Jul. 25, 2013

(54) MATRIX SUBSTRATE, DETECTING DEVICE, AND DETECTING SYSTEM

(71) Applicant: CANON KABUSHIKI KAISHA, Tokyo (JP)

(72) Inventors: Keigo Yokoyama, Honjo-shi (JP); Chiori Mochizuki, Sagamihara-shi (JP); Minoru Watanabe, Honjo-shi (JP); Masato Ofuji, Honjo-shi (JP); Jun Kawanabe, Kodama-gun (JP); Kentaro Fujiyoshi, Kumagaya-shi (JP); Hiroshi Wayama, Saitama-shi (JP)

(73) Assignee: CANON KABUSHIKI KAISHA, Tokyo (JP)

(21) Appl. No.: 13/744,089

(22) Filed: Jan. 17, 2013

(30) Foreign Application Priority Data
Jan. 19, 2012 (JP) 2012-009305

(51) Int. Cl. G09G 5/00

(52) U.S. Cl. CPC G09G 5/003
USPC 345/55

(57) ABSTRACT

A matrix substrate includes a plurality of pixels arranged in a matrix of rows and columns. In the matrix substrate a conducting voltage and a non-conducting voltage of a transistor included in a unit circuit including a demultiplexer that connects a plurality of connection terminals which are disposed to be smaller in number than the number of a plurality of driving lines which are connected in common to a plurality of pixels in a row direction and are arranged in parallel to each other in a column direction are supplied to a control line connected to a control electrode of a transistor at a frequency which is half a frequency at which a pixel is driven. Thus, a matrix substrate capable of suppressing the number of connection terminals and reducing power consumption is provided.

### BACKGROUND OF THE INVENTION

1. Field of the Invention

The present invention relates to a matrix substrate, a detecting device, and a detecting system, which may be applicable to a medical diagnostic imaging device, a non-destructive inspection device, an analyzing device using radiation, among others.

2. Description of the Related Art

In recent years, a thin film semiconductor manufacturing technique has been used for a matrix substrate with an array (a pixel array) of pixels in which switching elements such as thin film transistors (TFTs) are combined with conversion elements such as photoelectric conversion elements, and a detecting device or a radiation detecting device using the matrix substrate. In the detecting device, it is recently under review to form a demultiplexer on the same substrate as the pixel array. The following content is discussed in US Pat. No. 5,536,932. A detecting device includes a demultiplexer configured with a plurality of TFTs, which are disposed to correspond to a respective plurality of gate lines, between external gate terminals provided to correspond to terminals of external shift registers on a one-on-one basis and a plurality of gate lines (driving lines). Further, the demultiplexer sequentially selects the driving lines of the pixel array such that a clock signal (control signal) is applied to all of the plurality of TFTs via a clock line (control line).

Meanwhile, in U.S. Pat. No. 5,536,932, the clock signal (control signal) is applied to all of a plurality of TFTs via the clock line (control line) each time the demultiplexer sequentially selects the driving lines of the pixel array. For this reason, the frequency of the clock signal (control signal) in the clock line (control line) increases. Particularly, when the number of driving lines increases as the size and the resolution of the pixel array increase or when a scanning time of the gate line is reduced for a high-speed operation, the frequency of the clock signal (control signal) increases. As a result, power consumption caused by the clock line (control line) increases.

### SUMMARY OF THE INVENTION

The exemplary embodiments described in the present invention describe novel aspects of a detecting device, a detecting system, and a driving method of a detecting device, which are capable of restricting the number of external gate terminals and reducing power consumption.

According to an aspect of the present invention, a matrix substrate includes a plurality of pixels arranged in a matrix of rows and columns, a plurality of driving lines arranged in parallel in a column direction and connected in common to a plurality of pixels in a row direction, a plurality of connection terminals disposed to be smaller in number than the number of the plurality of driving lines connect a driving circuit that drives the plurality of pixels with the plurality of driving lines, and a demultiplexer that includes a plurality of unit circuits and a plurality of control lines and that connects the plurality of connection terminals to the plurality of driving lines, wherein each unit circuit among the plurality of unit circuits includes a plurality of transistors and connects a predetermined connection terminal among the plurality of connection terminals to two or more predetermined driving lines among the plurality of driving lines, wherein the plurality of control lines is connected to control electrodes of the plurality of transistors to supply a conducting voltage and a non-conducting voltage of the plurality of transistors, wherein the plurality of unit circuits include a predetermined unit circuit and another unit circuit adjacent to the predetermined unit circuit, and a control terminal of a transistor positioned to be closest to the other unit circuit among the plurality of transistors included in the predetermined unit circuit and a control terminal of a transistor positioned to be closest to the predetermined unit circuit among the plurality of transistors included in the other unit circuit are connected to a same control line among the plurality of control lines.

According to another aspect of the present invention, a detecting device includes the matrix substrate, the driving circuit, and a control circuit that supplies the control line with a conducting voltage and a non-conducting voltage of the transistor, wherein the control circuit supplies the control line with the conducting voltage and the non-conducting voltage of the transistor with a frequency which is half a frequency at which the plurality of pixels is driven.

Further, according to still another aspect of the present invention, a detecting device includes a plurality of pixels arranged in a matrix of rows and columns, a plurality of driving lines that are arranged in parallel in a column direction and connected in common to a plurality of pixels in a row direction, a driving circuit that drives the plurality of pixels, a plurality of connection terminals that are disposed to be smaller in number than the number of the plurality of driving lines and connect the driving circuit with the plurality of driving lines, and a demultiplexer that includes a plurality of unit circuits and a plurality of control lines and connects the plurality of connection terminals to the plurality of driving lines, and a control circuit that supplies the control line with the conducting voltage and the non-conducting voltage of the transistor, each unit circuit among the plurality of unit circuits including a plurality of transistors that connect a predetermined connection terminal among the plurality of connection terminals with two or more predetermined driving lines among the plurality of driving lines, the plurality of control lines being connected to control electrodes of the plurality of transistors to supply a conducting voltage and a non-conducting voltage of the transistor, wherein the control circuit supplies the control line with the conducting voltage and the non-conducting voltage of the transistor at a frequency which is half a frequency at which the pixel is driven.

According to the exemplary embodiment of the present invention, the frequency of the control signal (clock signal) can be reduced, and thus power consumption caused by the clock line can be reduced. Accordingly, the present invention can provide a detecting device, a detecting system, and a driving method of a detecting device, which are capable of restricting the number of external gate terminals and reducing power consumption.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1A is a circuit diagram for illustrating a first exemplary embodiment of a detecting device and a matrix substrate, according to the present invention.

FIG. 1B is a timing chart for illustrating timed circuit operations in the first exemplary embodiment of the detecting device.

FIG. 2A is a schematic cross-sectional view illustrating a pixel according to the detecting device and the matrix substrate.

FIG. 2B is a conceptual diagram of the detecting device.

FIG. 3 is a circuit diagram for illustrating a second exemplary embodiment of a detecting device and a matrix substrate, according to the present invention.

FIGS. 4A and 4B are timing charts for illustrating timed circuit operations in the second exemplary embodiment of the detecting device and the matrix substrate.

FIG. 5A is a conceptual diagram of the detecting device according to a third exemplary embodiment a detecting device and a matrix board, according to the present invention.

FIG. 5B is a circuit diagram for illustrating the third exemplary embodiment according to the detecting device and the matrix substrate.

FIG. 6 is a conceptual diagram of the detecting device for illustrating the third exemplary embodiment according to the detecting device and the matrix substrate.

FIGS. 7A and 7B are timing charts for illustrating timed circuit operations in the third exemplary embodiment according to the detecting device and the matrix board.

FIG. 8 is a conceptual diagram for illustrating an example in which the detecting device is applied to a detecting system.

### DESCRIPTION OF THE EMBODIMENTS

Various exemplary embodiments, features, and aspects of the invention will be described in detail below with reference to the drawings

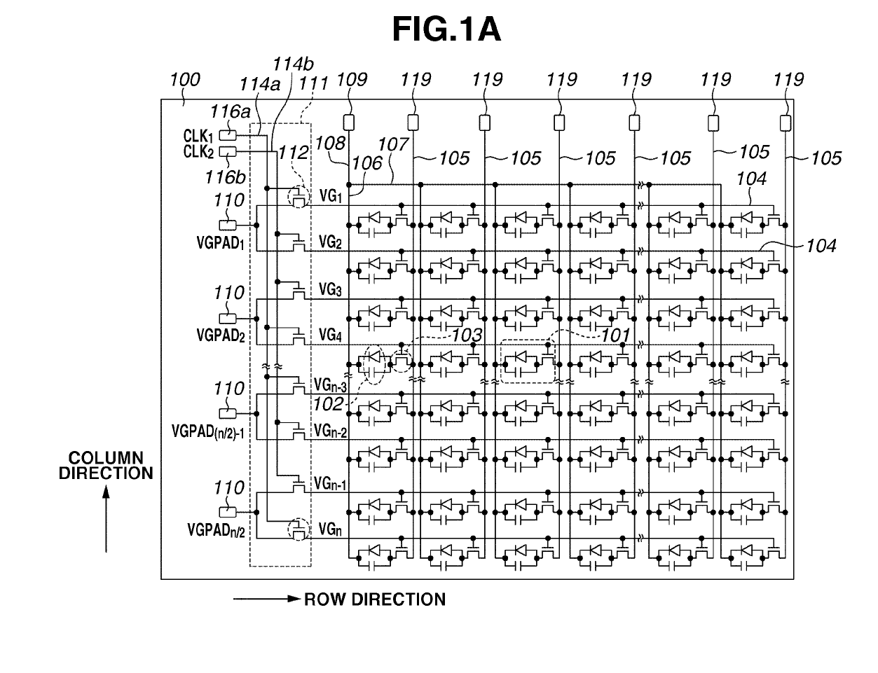

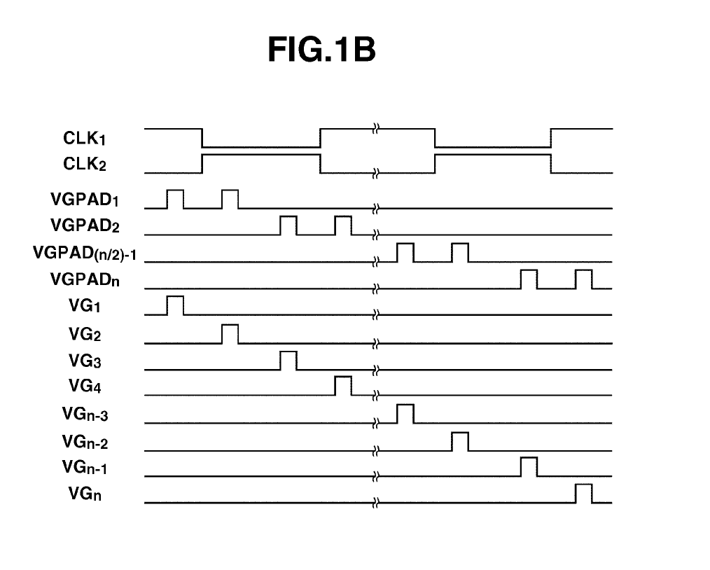

A first exemplary embodiment will be described. As illustrated in FIG. 1A, each of a matrix substrate for a detecting device, and a detecting device according to the present exemplary embodiment includes a pixel array including a plurality of pixels 101 which are arranged on a support substrate 100 in a matrix of rows and columns. A pixel 101 functions to output an electric signal in response to radiation or light incident thereupon. Each pixel 101 includes a conversion element 102 that converts the radiation or light into electric charges and a switching element 103 that outputs an electric signal according to the electric charges generated by the conversion element 102. Here, in the present exemplary embodiment, the conversion element 102 includes a scintillator that converts radiation into light and a photoelectric conversion element that converts the light into electric charges, but the present invention is not limited to this example. A direct-type conversion element that converts radiation directly to electric charges without using a scintillator may be used as the conversion element 102. Further, a TFT of amorphous silicon or polycrystalline silicon may be used as the switching element 103.

Here, silicon may be used for a TFT, but the present invention is not limited to this example, and any other semiconductor material such as germanium may be used. Moreover, a TFT of polycrystalline silicon can be used as the switching element 103. A first electrode of the conversion element 102 is electrically connected to a first main electrode of the switching element 103, and a second electrode of the conversion element 102 is electrically connected to a bias line 106. Referring to FIG. 1A, the bias line 106 extends in a column direction and is connected to be shared with a plurality of conversion elements 102 arranged in the column direction, via second electrodes thereof.

Further, a plurality of bias lines 106 are arranged in parallel in a row direction, and the plurality of bias lines 106 are connected to a common line 107 to become a common bias line 108. The common bias line 108 is electrically connected to an external power source circuit (not illustrated) via a connection terminal 109. A second main electrode of the switching element 103 is electrically connected to a signal line 105. The signal line 105 extends in the column direction and is connected to be shared with the plurality of switching elements 103 arranged in the column direction, via second main electrodes thereof.

Further, the plurality of signal lines 105 are arranged in parallel in the row direction, and each of the signal lines 105 is electrically connected to an external read circuit (not illustrated), via connection terminals 119. The connection terminals 109 and 119 are arranged between an end of the support substrate 100 and an effective pixel region.

The control electrode of the switching element 103 is electrically connected to a driving line 104 extending in the row direction. The driving line 104 is connected to be shared by the switching elements 103 of a plurality of pixels arranged in the row direction through control electrode thereof. Further, the plurality of driving lines 104 is arranged in parallel in the column direction, and electrically connected with an external driving circuit (not illustrated), via connection terminals 110. Here, the connection terminals 110 are arranged on the support substrate 100 between an end of a certain side of the support substrate 100 and the pixel array.

Further, the number of connection terminals 110 is smaller than the number of driving lines 104. That is, the number of connection terminals 110 is smaller than the number of pixel rows of the pixel array. In the present embodiment, a ratio of the number of connection terminals 110 to number of pixel rows is 1 to 2. In other words, in the present embodiment, for every two rows of pixels only one connection terminal 110 is provided. This arrangement enables the use of a reduced number of external gate terminals and a reduction in power consumption. To that end, a demultiplexer 111 in which the plurality of connection terminals 110 are connected with the plurality of driving lines 104 is arranged between the plurality of connection terminals 110 and the plurality of driving lines 104. The demultiplexer 111 includes two or more first transistors (first TFTs) 112 which are respectively disposed on two or more driving lines 104 on a one-on-one basis between one connection terminal 110 and the corresponding two or more driving lines 104.

The first TFT 112 corresponds to a transistor of a unit circuit in the present invention. In addition, in the present invention, an element present between one connection terminal 110 and the corresponding two or more driving lines 104 is referred to as a unit circuit of a demultiplexer. Further, an element associated with the driving line 104 corresponding to a first row of each of unit circuits is referred to as a first stage element, an element associated with the driving line 104 corresponding to a second row is referred to as a second stage element, and subsequent elements are referred to, for example, third and fourth stage elements. Furthermore, FIG. 1A illustrates a configuration in which each of the unit circuits includes first and second stage elements.

In the present exemplary embodiment, each of the unit circuits includes two first TFTs 112. The first TFT 112 functions to supply each of the two or more driving lines 104 with a conducting voltage of the switching element 103, and one of two main electrodes of the first TFT 112 is electrically connected to the connection terminal 110, and the other is electrically connected with the corresponding driving line 104. Further, the conducting voltage is a voltage to cause a pixel to be in a selected state, and corresponds to a first voltage of the present invention. Further, first control lines 114a and 114b through which a conducting voltage and a non-conducting voltage of a TFT are supplied to the control electrode of the first TFT 112 are provided. The first control lines 114a and 114b correspond to a control line in the present invention.

In the present exemplary embodiment, the two first control lines 114a and 114b are disposed, and control signals CLK1 and CLK2 are supplied from an external control circuit (not illustrated) via first connection terminals 116a and 116b, respectively. In the following description, a unit circuit corresponding to a row first selected in the pixel array is referred to as a first unit circuit, and subsequent unit circuits are referred to as a second unit circuit and a third unit circuit in the order that an arrangement thereof is close to the first unit circuit. Further, an odd number-th unit circuit such as the first unit circuit or the third unit circuit is referred to as an odd-numbered unit circuit, and an even number-th unit circuit such as the second unit circuit or the fourth unit circuit is referred to as an even-numbered unit circuit.

In the odd-numbered unit circuit, the control electrodes of the first TFTs 112 of the first stage are electrically connected in common to the first control line 114a, and the control electrodes of the first TFTs 112 of the second stage are electrically connected in common to the first control line 114b. Meanwhile, in even-numbered unit circuits adjacent to the odd-numbered unit circuits, the control electrodes of the first TFTs 112 of the first stage are electrically connected in common to the first control line 114b, and the control electrodes of the first TFTs 112 of the second stage are electrically connected in common to the first control line 114a.

In other words, the first control line 114 has the following connection relation when a predetermined unit circuit (for example, the third unit circuit) and another unit circuit adjacent thereto (for example, the fourth unit circuit) are present. The control terminal of the TFT arranged at the position closest to another unit circuit among a plurality of TFTs included in the predetermined unit circuit and the control terminal of the TFT arranged at the position closest to the predetermined unit circuit among a plurality of TFTs included in another unit circuit are connected in common to the same first control line. The first control line 114a is electrically connected to the first connection terminal 116a, and the first control line 114b is electrically connected to the first connection terminal 116b.

In addition, the demultiplexer 111 of the present exemplary embodiment is configured to perform a one-to-two demultiplexing operation, but the present invention is not limited to this example. The demultiplexer 111 may be configured to perform a one-to-N (where N is an integer equal to two or more) demultiplexing operation. An integrated circuit (IC) can be used as each external circuit connected to each connection terminal. When an integrated circuit is used, each circuit may be individually disposed in the integrated circuit, some or all circuits may be disposed in the same integrated circuit.

Next, an operation of the demultiplexer 111 of the present exemplary embodiment will be described with reference to FIGS. 1A and 1B. Here, in FIG. 1B, a control signal VGPAD1 is supplied to the connection terminal 110 corresponding to the driving lines 104 of first and second rows, and a control signal VGPAD2 is supplied to the connection terminal 110 corresponding to the driving lines 104 of third and fourth rows. Similarly, a control signal VGPAD(n/2)−1 is supplied to the connection terminal 110 corresponding to the driving lines 104 of (n−3) -th and (n−2)-th rows, and a control signal VGPADn/2 is supplied to the connection terminal 110 corresponding to the driving lines 104 of (n−1)-th and n-th rows.

Further, a control signal CLK1 is supplied to the first connection terminal 116a, and a control signal CLK2 is supplied to the control terminal 116b. Furthermore, VG1 to VGn are voltages of the driving lines 104 of the first to n-th rows respectively. First, CLK1 functions as a conducting voltage (hereinafter, referred to as “Hi”) of the first TFT 112. The Hi voltage is larger than a value obtained by adding a threshold voltage of the first TFT 112 to a Vcom voltage which will be described later. Meanwhile, CLK2 functions as a non-conducting voltage (hereinafter, referred to as “Lo”) of the first TFT 112.

In this time period, when a voltage is applied, VGPAD1 has a voltage (hereinafter, referred to as “Vcom”) equal to or larger than the conducting voltage of the switching element 103, and VGPAD2 to VGPADn/2 has a non-conducting voltage (hereinafter, referred to as “Voff”) of the switching element 103. As a result, a voltage VG1 of the driving line 104 of the first row which is a predetermined driving line becomes a conducting voltage (hereinafter, referred to as “Von”) of the switching element 103, and voltages VG2 to VGn of the driving lines 104 which are driving lines different from the predetermined driving line become Voff.

Next, in a state in which CLK1 is Hi and CLK2 is Lo, VGPAD1 to VGPADn/2 become Voff. As a result, all of VG1 to VGn become Voff. Next, CLK1 transitions to Lo, CLK2 transitions to Hi, and then VGPAD1 becomes Vcom again. Further, VGPAD2 to VGPAD2n/2 become Voff. As a result, VG2 becomes Von, VG1 and VG3 to VGn become Voff. This is a demultiplexer operation of a first unit block of the demultiplexer 111.

Next, in a state in which CLK1 is Lo and CLK2 is Hi, VGPAD1 to VGPADn/2 become Voff. As a result, all of VG1 to VGn become Voff. Next, in a state in which CLK1 is Lo and CLK2 is Hi, VGPAD2 becomes Vcom, VGPAD1, and VGPAD3 to VGPADn/2 become Voff. As a result, VG3 becomes Von, VG1, VG2, and VG4 to VGn become Voff. Next, in a state in which CLK1 is Lo and CLK2 is Hi, VGPAD1 to VGPADn/2 become Voff. As a result, all of VG1 to VGn become Voff.

Further, CLK1 transitions to Hi, CLK2 transitions to Lo, and then VGPAD2 becomes Vcom again. Further, VGPAD1, and VGPAD3 to VGPADn+2 become Voff. As a result, VG4 becomes Von, VG1 to VG3 and VG5 to VGn become Voff. This is a demultiplexer operation of a second unit block of the demultiplexer 111. Then, the same process is sequentially performed until a demultiplexer operation of an n/2-th unit block of the demultiplexer 111, and so the switching elements 103 are sequentially scanned in units of rows.

As described above, using the demultiplexer 111, the number of connection terminals 110 connected to the external driving circuit can be reduced to a fraction of the number of unit circuits at maximum. However, a total of the number of the connection terminals is increased by the number of the first connection terminals 116a and 116b for components included in a unit block.

Here, a frequency f of the control signal CLK1 or CLK2 means the number of times in which the control signal oscillates for one second, that is, the number of times that voltage of a maximum value (Hi) and a minimum value (Lo) repeats for one second, and a reciprocal 1/f thereof means one period of the control signal.

Power consumption P of the first control line 114a or 114b depends on a capacitance value C applied to the first control line 114a or 114b, the frequency f of the control signal CLK1 or CLK2, and the square of a differential voltage (Hi-Lo) between Hi and Lo. In other words, the power consumption P is expressed by P=f×C×(Hi-Lo)². For this reason, when the frequency f of the control signal CLK1 or CLK2 is reduced by half, the power consumption of the first control line 114a or 114b is reduced by half.

In the related art, when each time Von is supplied to one driving line 104 and so pixels are driven, it is necessary to apply the control signal CLK1 or CLK2 of one period to the control line. On the other hand, in the present exemplary embodiment, when each time Von is sequentially supplied to the two driving lines 104, the control signal CLK1 or CLK2 of one period is applied to the first control line 114a or 114b.

In other words, in the present exemplary embodiment, one period of the control signal CLK1 or CLK2 is twice compared to the related art, the frequency is ½ compared to the related art, and thus the power consumption of the control line to one driving line 104 becomes half compared to the related art. This is advantageous, particularly, when the number of the driving lines 104 is large as the size of the pixel array increases or the resolution increases or when a period (scanning frequency) F with which Von is sequentially supplied to the driving line 104 for the high-speed operation is high.

It is because when the number of the driving lines 104 increases, the number of the first TFTs 112 connected to the first control line 114a or 114b increases, the capacitance value C of the first control line 114a or 114b increases, and power consumption in the first control line 114a or 114b increases. Further, it is because when the scanning frequency F of the high-speed operation increases, in order to cope with the high-speed operation, it is necessary to increase the gate capacitance of the first TFT 112, the capacitance value C of the first control line 114a or 114b increases, and thus power consumption in the first control line 114a or 114b is increased. Particularly, when power consumption in the first control line 114a or 114b (power consumption in the demultiplexer 111) is larger than the power consumption in the driving line 104 (power consumption in the pixel array), the effects of the present invention are remarkable.

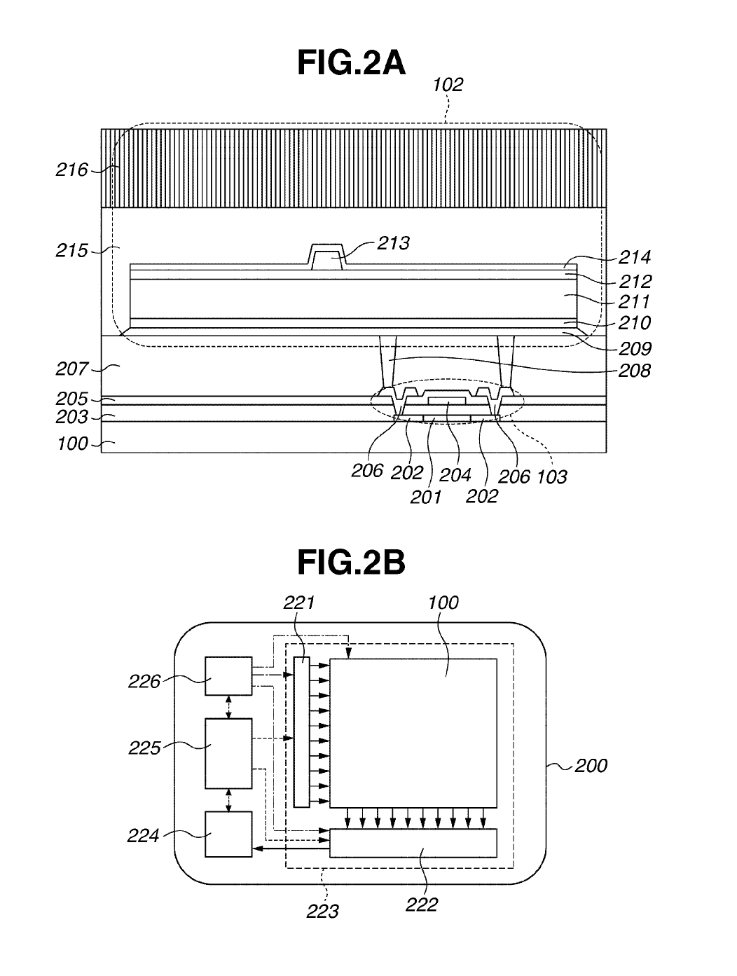

Next, a cross-sectional structure of the pixel 101 according to the present exemplary embodiment will be described with reference to FIG. 2A. In the pixel 101 according to the present exemplary embodiment, the conversion element 102 and the switching element 103 are arranged corresponding to each other on a one-on-one basis. The switching element 103 is disposed on a support substrate 100 with an insulating surface such as a glass substrate, and includes a first semiconductor layer 201, a first extrinsic semiconductor layer 202, a first insulating layer 203, a first conductive layer 204, a second insulating layer 205, and a second conductive layer 206. The first semiconductor layer 201 functions as a channel region of a TFT, the first extrinsic semiconductor layer 202 functions as a source or drain region, the first insulating layer 203 functions as a gate insulating layer, the second conductive layer 204 functions as a gate electrode, and the third conductive layer 206 functions as a source or drain electrode.

Here, the gate electrode corresponds to the control electrode in the description of FIGS. 1A and 1B, and the source or drain electrode corresponds to the main electrode. In FIGS. 2A and 2B, a staggered-type TFT in which the first semiconductor layer 201 is made of polycrystalline silicon is used. When the staggered-type TFT using the same polycrystalline silicon is used as the first TFT 112, the manufacturing process is simplified.

Further, the conversion element 102 is arranged above a third insulating layer 207 covering the switching element 103. A photoelectric conversion element configuring the conversion element 102 includes a fourth conductive layer 209, a second extrinsic semiconductor layer 210, a second semiconductor layer 211, a third extrinsic semiconductor layer 212, a fifth conductive layer 213, and a sixth conductive layer 214. The fourth conductive layer 209 is electrically connected to the third conductive layer which is the first main electrode of the switching element 103 through a third conductive layer 208, and functions as the first electrode. N-type impurity is doped into the second extrinsic semiconductor layer 210, and p-type impurity is doped into the third extrinsic semiconductor layer 212. The second semiconductor layer 211 functions as a photoelectric conversion layer of the photoelectric conversion element, the fifth conductive layer 213 functions as the bias line 106, and the sixth conductive layer 214 functions as the second electrode.

Further, a scintillator 216 is disposed above a fourth insulating layer functioning as a planarization layer covering a plurality of photoelectric conversion elements. The conversion element 102 and the switching element 103 may be appropriately formed using a known vapor deposition technique, an etching technique, and a photolithography technique. In the present exemplary embodiment, use of the PIN-type photodiode using the second extrinsic semiconductor layer 210 as the photoelectric conversion element has been described, but the present invention is not limited to this example. A MIS-type photo sensor using an insulating layer instead of the second extrinsic semiconductor layer 210 may be used.

Next, a device configuration of the detecting device of the present invention will be described with reference to FIG. 2B. A detecting device 200 includes the support substrate 100 that includes at least the pixel array, the demultiplexer 111, and the connection terminal 110. The detecting device 200 includes a detecting unit 223 that includes the support substrate 100, a driving circuit 221 that drives the pixel array, and a read circuit 222 that outputs an electric signal from the pixel array as image data. The driving circuit 221 is electrically connected to the connection terminal 110, and outputs Vcom and Voff.

In other words, the driving circuit 221 drives the pixel by controlling a selection (selected) state and a non-selection (non-selected) state of the pixel. The read circuit 222 is electrically connected to the connection terminal 119. The detecting device 200 further includes a signal processing unit 224 that processes image data from the detecting unit 223 and outputs the processed image data, a the control circuit 225 that supplies a control signal to each component and controls an operation of the detecting unit 223, and a power source circuit 226 that supplies each component with a bias.

The signal processing unit 224 receives a control signal from a control computer (not illustrated) and provides the control signal to the control circuit 225. The signal processing unit 224 receives potential information of the signal line 105 from the read circuit 222 during an irradiation time period of radiation, and transmits the potential information to the control computer (not illustrated). The power circuit 226 includes a regulator that receives a voltage from an external power source (not illustrated) or a built-in battery, and supplies a voltage which is necessary in the pixel array, the driving circuit 221, and the read circuit 222. The power circuit 226 is electrically connected to the connection terminal 109. The control circuit 225 is electrically connected to the first connection terminals 116a and 116b, and outputs the control signals CLK1 and CLK2.

Each of the driving circuit 221, the read circuit 222, the signal processing unit 224, the control circuit 225, and the power source circuit 226 is illustrated by one block, but it does not mean that each unit is configured with one integrated circuit. Each unit may be configured with a plurality of integrated circuits or all units may be provided in one integrated circuit. Further, the above description can be appropriately applied to other exemplary embodiments of the present invention.

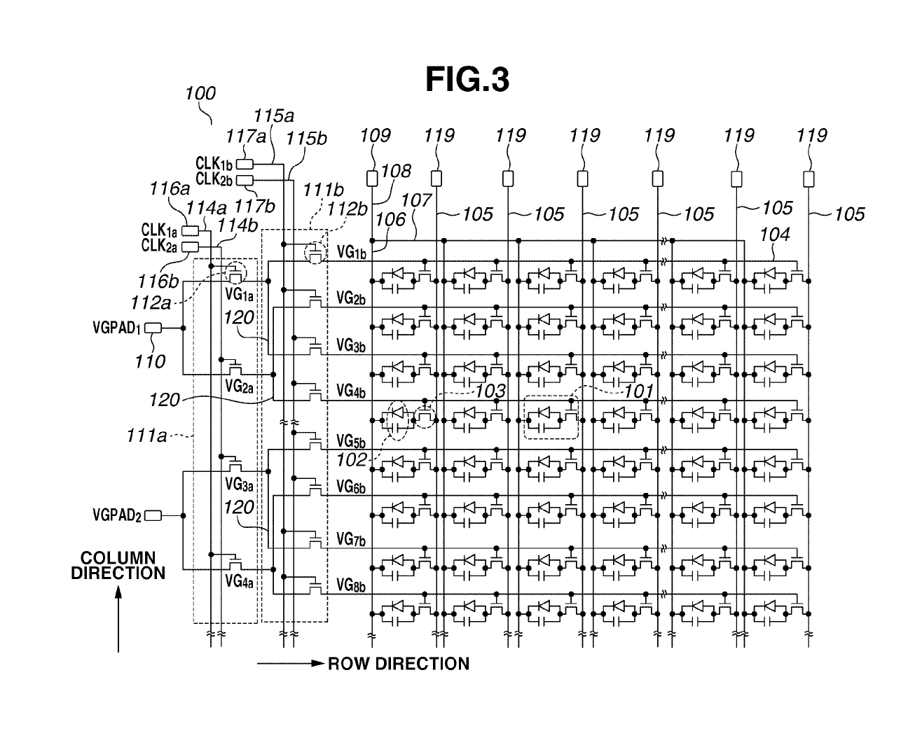

A second exemplary embodiment will be described. Next, the second exemplary embodiment will be described with reference to FIGS. 3A and 3B. Differences from the first exemplary embodiment will be described below in detail, and a detail description will be omitted such that the same components as in the first exemplary embodiment are denoted by the same reference numerals.

In the first exemplary embodiment illustrated in FIG. 1A, the demultiplexer 111 including the unit circuit with the two first TFTs 112 which are disposed to respectively correspond to the two driving lines 104 on a one-on-one basis between one connection terminal 110 and the corresponding two driving lines 104 is used. However, in the present exemplary embodiment, a unit block of a first demultiplexer circuit 111a having two first TFTs 112a is disposed between one connection terminal 110 and corresponding four driving lines 104 as illustrated in FIG. 3.

Further, a unit block of a second demultiplexer circuit 111b having four second transistors (second TFTs) 112b is disposed between the unit block of the first demultiplexer circuit 111a and the corresponding four driving lines 104. Furthermore, the unit block of the first demultiplexer circuit 111a connecting with one connection terminal 110 is serially connected with the unit block of the second demultiplexer circuit 111b connected with the four driving lines 104 via a connection node 120.

Thus, the unit block of the first demultiplexer circuit 111a and the unit block of the second demultiplexer circuit 111b configure the unit circuit of the demultiplexer. In other words, the demultiplexer of the present exemplary embodiment is configured such that two one-on-two demultiplexer circuits are serially connected with each other. In the present exemplary embodiment, in the unit block of the first demultiplexer circuit 111a, an element related to the connection node 120 connected with the driving line 104 corresponding to a first row of each unit block is referred to as a first stage. Similarly, an element related to the connection node 120 connected with the driving line 104 corresponding to a second row of each unit block is referred to as a second stage.

Further, in the unit block of the second demultiplexer circuit 111b, an element related to the driving line 104 corresponding to a first row of each unit block is referred to as a first stage, an element related to the driving line 104 corresponding to a second row of each unit block is referred to as a second stage, and elements related to the driving lines 104 corresponding to subsequent rows are referred to as third and four stages, respectively. The first TFT 112a of the first stage is connected with the second TFT 112b of the first stage and the second TFT 112b of the third stage, and the first TFT 112a of the second stage is connected with the second TFT 112b of the second stage and the second TFT 112b of the fourth stage. In addition to the first control lines 114a and 114b, second control lines 115a and 115b that supplies the control electrode of the second TFT 112b with the conducting voltage and the non-conducting voltage of the TFT are provided.

In the present exemplary embodiment, the two second control lines 115a and 115b are provided, and control signals CLK1b and CLK2b are supplied from an external control circuit (not illustrated) via second connection terminals 117a and 117b, respectively. Meanwhile, the first control lines 114a and 114b are supplied with the control signals CLK1a and CLK2a from the external control circuit (not illustrated) via the first connection terminal 116a and 116b. In the following, a unit block corresponding to a row first selected in the pixel array is referred to as a first unit block, and subsequent unit blocks are referred to as a second unit block and a third unit block in the order that an arrangement thereof is close to the first unit block. Further, an odd number-th unit block such as the first unit block or the third unit block is referred to as an odd-numbered unit block, and an even number-th unit block such as the second unit block or the fourth unit block is referred to as an even-numbered unit block.

In the odd-numbered unit block of the first demultiplexer circuit 111a, the control electrodes of the first TFTs 112a of the first stage are electrically connected in common to the first control line 114a, similarly to the demultiplexer 111 of the first exemplary embodiment. Further, the control electrodes of the first TFTs 112b of the second stage are electrically connected in common to the first control line 114b. Meanwhile, in the neighboring even-numbered unit block, the control electrodes of the first TFTs 112a of the first stage are electrically connected in common to the first control line 114b, and the control electrodes of the first TFTs 112a of the second stage are electrically connected in common to the first control line 114a.

In other words, in the first demultiplexer circuit 111a, the following connection relation is made when a predetermined unit block and another unit block adjacent thereto are present. The control terminal of the TFT arranged at the position closest to another unit block among a plurality of TFTs included in the predetermined unit block and the control terminal of the TFT arranged at the position closest to the predetermined unit block among a plurality of TFTs included in another unit block are connected in common to the same control line.

Next, in the odd-numbered unit block of the second demultiplexer circuit 111b, the control electrodes of the second TFT 112b of the first and second stages are electrically connected in common to the second control line 115a. Further, the control electrodes of the second TFT 112b of the third and fourth stages are electrically connected in common to the second control line 115b. Meanwhile, in the neighboring even-numbered unit block, the control electrodes of the first TFT 112b of the first and second stages are electrically connected in common to the second control line 115b, and the control electrodes of the first TFT 112b of the third and fourth stages are electrically connected in common to the second control line 115a.

In other words, in the second demultiplexer circuit 111b, the following connection relation is made when a first unit block and another unit block adjacent thereto are present. The control terminal of the TFT arranged at the position closest to another unit block among a plurality of TFTs included in the predetermined unit block and the control terminal of the TFT arranged at the position closest to the predetermined unit block among a plurality of TFTs included in another unit block are connected in common to the same control line. Further, in one unit block, TFTs for two stages are connected to the same control lines.

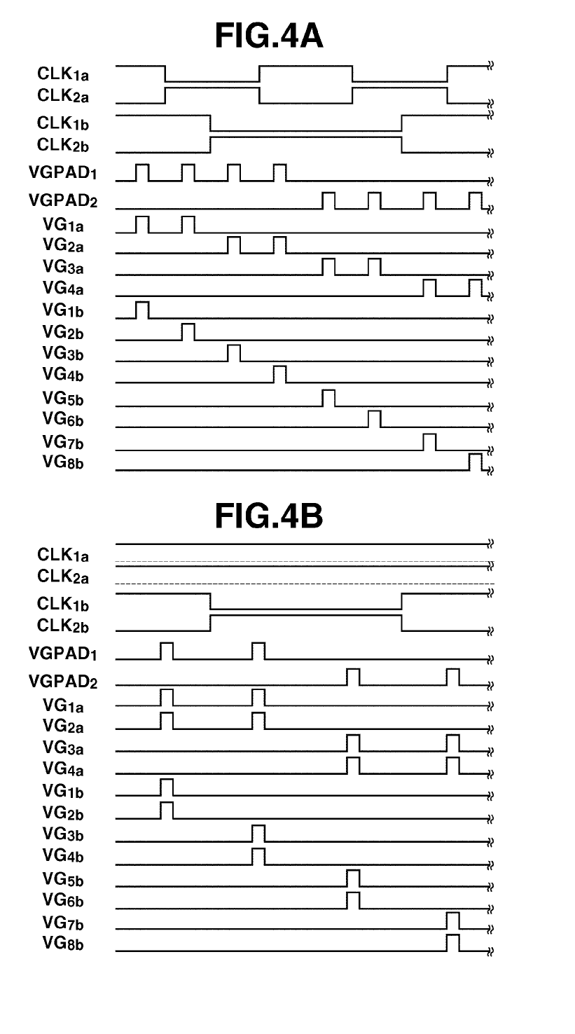

Next, an operation of the demultiplexer of the present exemplary embodiment will be described with reference to FIGS. 3 and 4A. Here, in FIG. 4A, a control signal VGPAD1 is supplied to the connection terminal 110 corresponding to the driving lines 104 of first to fourth rows, and a control signal VGPAD2 is supplied to the connection terminal 110 corresponding to the driving lines 104 of fifth to eighth rows.

Further, a control signal CLK1a is supplied to the first connection terminal 116a, a control signal CLK2a is supplied to the first connection terminal 116b, a control signal CLK1b is supplied to the second connection terminal 117a, and a control signal CLK2b is supplied to the second connection terminal 117b. Furthermore, VG1b to VG8b are voltages of the driving lines 104 of the first to eighth rows, respectively. Here, in the present exemplary embodiment, the control signals CLK1a and CLK2a of one period may be applied to the first demultiplexer circuit 111a each time Von is sequentially supplied to the two driving lines 104. Meanwhile, the control signals CLK1b and CLK2b of one period may be applied to the second demultiplexer circuit 111b each time Von is sequentially supplied to the four driving lines 104.

First, CLK1a and CLK1b become Hi, and CLK2a and CLK2b become Lo. In this time period, a voltage is applied, and thus VGPAD1 becomes Vcom, and VGPAD2 is in the Voff state. Thus, the voltage VG1b of the driving line 104 of the first row which is the predetermined driving line becomes the conducting voltage Von of the switching element 103, and the voltages VG2b to VG8b of the driving lines 104 which are driving lines different from the predetermined driving line become Voff.

Next, VGPAD1 becomes Voff, and in a state in which CLK1b is Hi and CLK2b is Lo, CLK1a transitions to Lo, and CLK2a transitions to Hi. In this time period, VGPAD1 becomes Vcom again. VGPAD2 is in the Voff state. Thus, the voltage VG2b of the driving line 104 of the second row which is the predetermined driving line becomes the conducting voltage Von of the switching element 103, and the voltages VG1b and VG3b to VG8b of the driving lines 104 which are driving lines different from the predetermined driving line become Voff.

Next, VGPAD1 becomes Voff, CLK1b transitions to Lo, CLK2b transitions to Hi, CLK1a remains in Lo, and CLK2a remains in Hi. In this time period, VGPAD1 becomes Vcom again. VGPAD2 is in the Voff state. Thus, the voltage VG3b of the driving line 104 of the third row which is the predetermined driving line becomes the conducting voltage Von of the switching element 103, and the voltages VG1b to VG2b and VG4b to VG8b of the driving lines 104 which are driving lines different from the predetermined driving line become Voff. Then, the same process is sequentially performed, and so the switching elements 103 are sequentially scanned in units of rows.

As described above, using the demultiplexer 111, the number of connection terminals 110 connected to the external driving circuit can be reduced to a fraction of the stage number of unit blocks at maximum. However, the second connection terminals 117a and 117b are added to the connection terminals as a whole.

FIG. 4B illustrates a timing chart when a 2-pixel addition is performed. As illustrated in FIG. 4B, by fixing CLK1a and CLK2a to Hi, an operation of the 2-pixel addition can be easily performed. Since CLK1a and CLK2a are fixed to Hi, power consumption in the demultiplexer is further reduced.

In the present exemplary embodiment, in the first demultiplexer circuit 111a, the number of the first TFTs 112a is half as large as the number of the first TFTs 112 of the first exemplary embodiment. Meanwhile, the number of TFTs is increased by the number of the second TFTs 112b compared to the first exemplary embodiment, but the control signal supplied to the second demultiplexer circuit 111b may have one period which is twice as long as the control signal of the first exemplary embodiment. Thus, power consumption of the demultiplexer of the present exemplary embodiment can be reduced, similarly to the first exemplary embodiment.

The present exemplary embodiment has been described in connection with the example of the demultiplexer having the configuration in which the two one-on-two demultiplexer circuits are serially connected to each other, but a demultiplexer in which m (m is a natural number larger than 1) multiplexers are serially connected to one another may be configured as follows. Here, a first demultiplexer circuit is positioned to be electrically closest to the connection terminal 110, and an m-th demultiplexer circuit is positioned to be electrically closest to the driving line 104 . The (m−1)-th demultiplexer circuit includes (2m−1) (m−1)-th TFTs, and the m-th demultiplexer circuit includes 2m m-th TFTs. The m-th TFTs of the first and third stages of the m-th demultiplexer circuit are connected to the (m−1)-th TFT of the first stage of the (m−1)-th demultiplexer circuit. Further, the m-th TFTs of the second and fourth stages of the m-th demultiplexer circuit are connected to the (m−1)-th TFT of the second stage of the (m−1)-th demultiplexer circuit.

This connection is made by a 2m-th stage of the m-th demultiplexer circuit. Further, in one unit block of the m-th demultiplexer circuit, the control terminals of the m-th TFTs of the first to (2m−1)-th stages are connected in common to the control line, and the control terminals of the m-th TFTs of the (2m−1)+1-th to 2m-th stages are connected in common to another control line. In the m-th demultiplexer circuit, the control signal of one period is supplied each time Von is sequentially supplied to the 2m−1 driving lines 104.

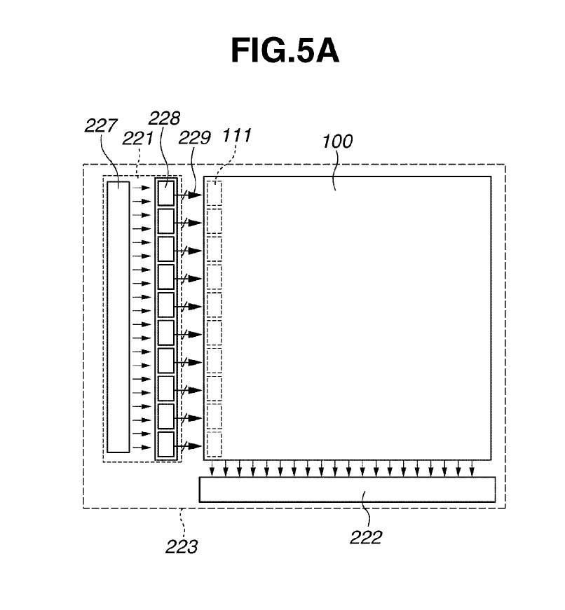

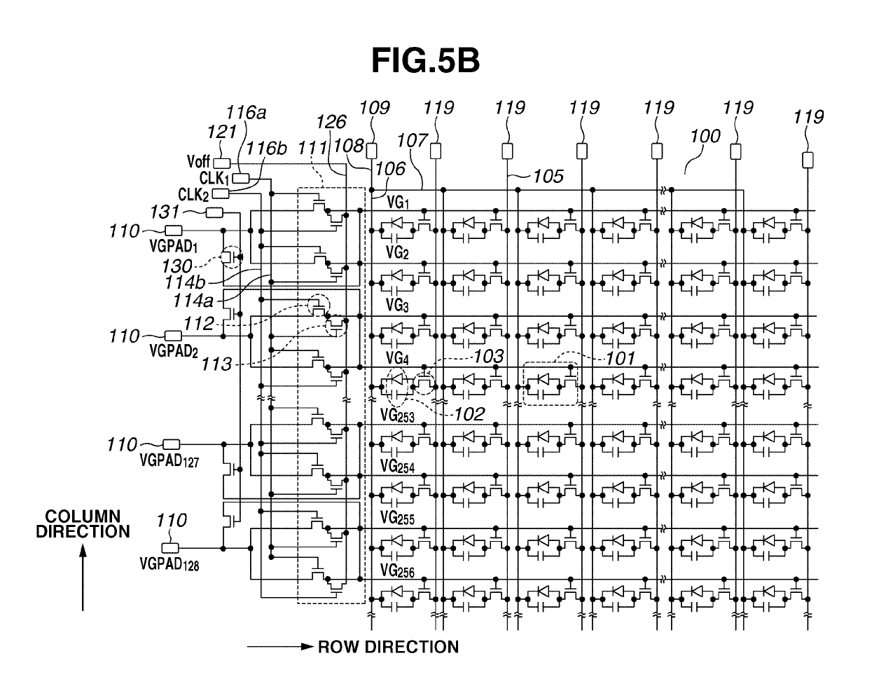

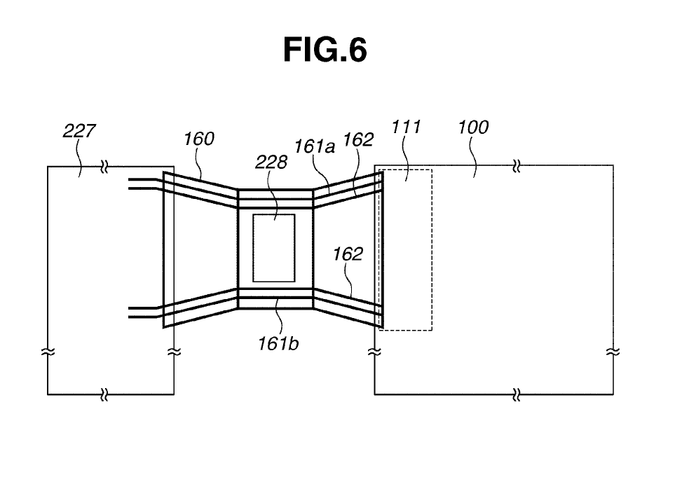

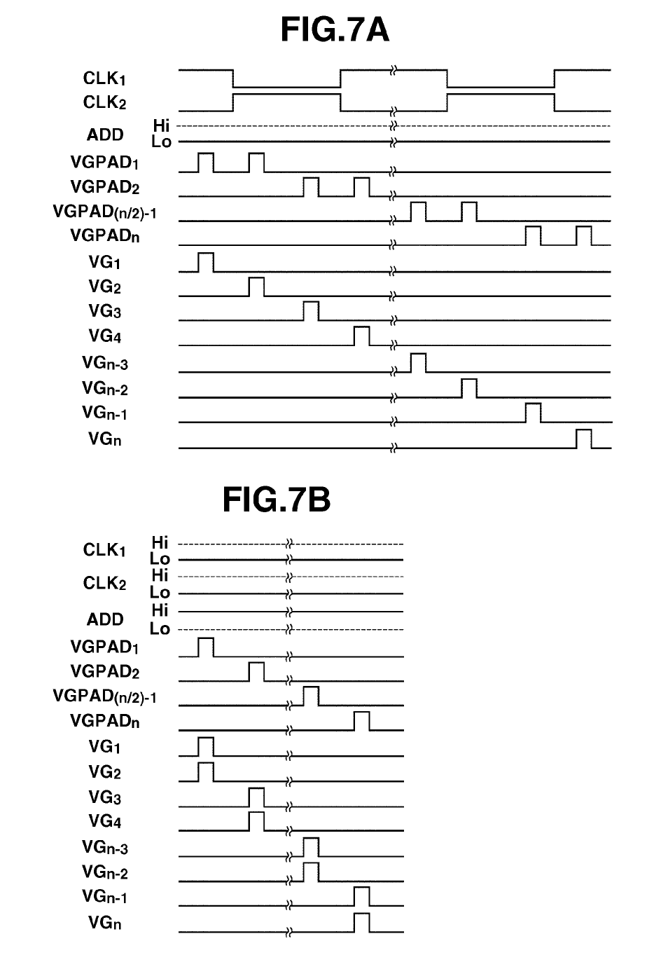

A third exemplary embodiment will be described. Next, the third exemplary embodiment will be described with reference to FIGS. 5A, 5B, 6, 7A, and 7B. Here, FIG. 5A is a block diagram for describing a detecting unit 223 according to the present exemplary embodiment, FIG. 5B is an equivalent circuit diagram for describing the detecting unit 223 according to the present exemplary embodiment, FIG. 6 is an enlarged block diagram of a part of the detecting unit 223 according to the present exemplary embodiment, and FIG. 7A and FIG. 7B are timing charts for describing an operation according to the present exemplary embodiment. A difference with the first exemplary embodiment will be described below in detail, and a detail description will be given, although the same components as in the first exemplary embodiment are denoted by the same reference numerals and detailed description thereof is omitted.

As illustrated in FIG. 5A, in the present exemplary embodiment, a driving circuit 221 includes a driving print circuit board 227 and a plurality of (for example, 10) driving integrated circuits 228. In other words, a plurality of demultiplexers 111 is disposed on a one-on-one basis corresponding to the driving integrated circuit 228. In the present exemplary embodiment, the ten demultiplexers 111 are disposed. Here, the driving print circuit board 227 supplies each driving integrated circuit 228 with a signal or electric power, and each driving integrated circuit 228 supplies the corresponding demultiplexer 111 with a signal group 229 such as a control signal and various kinds of voltages.

As illustrated in FIG. 5B, in the present exemplary embodiment, a third transistor (a third TFT) 113 that supplies the driving line 104 with Voff (a second voltage) is disposed for each driving line 104 in each unit of the demultiplexer 111. The third TFT 113 is arranged between a power line 126 connected to a third connection terminal 121 to which only Voff is applied and the driving line 104. The control terminal of the third TFT 113 is connected to one of the first control lines 114a and 114b which is different from the control line connected to the control terminal of the first TFT connected to the same driving line 104. Further, a fourth transistor (a fourth TFT) 130 that supplies the two driving lines 104 corresponding to one connection terminal 110 with a control signal VGPAD supplied to the corresponding connection terminal 110 is disposed on the support substrate 100 without the first TFT 112.

The fourth TFT 130 is arranged between the two driving lines 104 corresponding to one connection terminal 110 and the corresponding connection terminal 110 in each unit circuit of the demultiplexer 111. The fourth TFT 130 is arranged in parallel to the first TFT 112. The control terminal of each fourth TFT 130 is electrically connected to the fourth connection terminal 131 supplied with a mode selection signal ADD. The mode selection signal ADD is a signal to select a first mode in which reading is sequentially performed in units of one rows or a second mode in which reading is sequentially performed in units of two rows (pixel addition mode) according to a constant voltage of Hi or Lo. In the present exemplary embodiment, for example, the demultiplexer 111 is disposed to correspond to the driving lines 104 of 256 rows which correspond to one driving circuit 228, and 128 connection terminals 110 are disposed. Further, the first control lines 114a and 114b are divided to correspond to each the driving integrated circuit 228.

As illustrated in FIG. 6, the driving integrated circuit 228 is disposed in a flexible printed circuit 160 and bonded to a wiring of the flexible printed circuit 160. In other words, the driving circuit 221 includes a plurality of flexible printed circuits 160 with the driving integrated circuit 228. The wiring bonded to the driving integrated circuit 228 is connected to each connection terminal 110 by a tape automated bonding (TAB) mounting technique, and transmits each control signal VGPAD. Among the wirings of the flexible printed circuit 160, wirings 161a and 161b positioned outside the wiring bonded to the driving integrated circuit 228 are connected to the first connection terminals 116a and 116b, and transmits the control signals CLK1 and CLK2.

In other words, the divided first control interconnections 114a and 114b are electrically connected to the wirings 161a and 161b, respectively, for each flexible printed circuit 160. An wiring 162 positioned between the wiring bonded to the driving integrated circuit 228 and the wirings 161a and 161b is connected to the third connection terminal 121 or the fourth connection terminal 131, and transmits the non-conducting voltage Voff or the mode selection signal ADD. The wiring 162 transmits a constant voltage or a signal of a constant voltage, so that the wiring 162 functions as a shield to suppress noise from being mixed with the control signal VGPAD due to potential change of the control signal which is transmitted through the interconnections 161a and 161b. Such a plurality of (for example, 10) flexible printed circuits 160 with the driving integrated circuit 228 are disposed.

Next, an operation of the demultiplexer 111 of the present exemplary embodiment will be described with reference to FIGS. 7A and 7B. Here, FIG. 7A illustrates an operation of the first mode, and FIG. 7B illustrates an operation of the second mode. As illustrated in FIG. 7A, the operation of the demultiplexer 111 in the first mode is similar to the operation of the first exemplary embodiment illustrated in FIG. 1B except the following point. Firstly, the mode selection signal ADD is fixed to Lo. Thus, the fourth TFT 130 becomes the electrically non-conducting state. Secondly, the driving line 104 is fixed to Voff as each third TFT 113 becomes electrically conductive. Thus, even when the first TFT 112 is in the non-conductive state, the potential of the driving line 104 is fixed to Voff. Further, the control signals CLK1 and CLK2 are not simultaneously supplied to all the demultiplexers 111, and the control signals CLK1 and CLK2 can be supplied only to a desired demultiplexer 111, and thus power consumption can be further reduced.

Next, as illustrated in FIG. 7B, the operation of the demultiplexer 111 in the second mode has features in the following points. Firstly, the mode selection signal ADD is fixed to Hi, and the control signals CLK1 and CLK2 are fixed to Lo. Secondly, each control signal VGPAD is sequentially supplied to the connection terminal 110. Thus, pixel addition can be performed such that each control signal VGPAD is sequentially supplied for every two driving lines 104 without the first TFT 112.

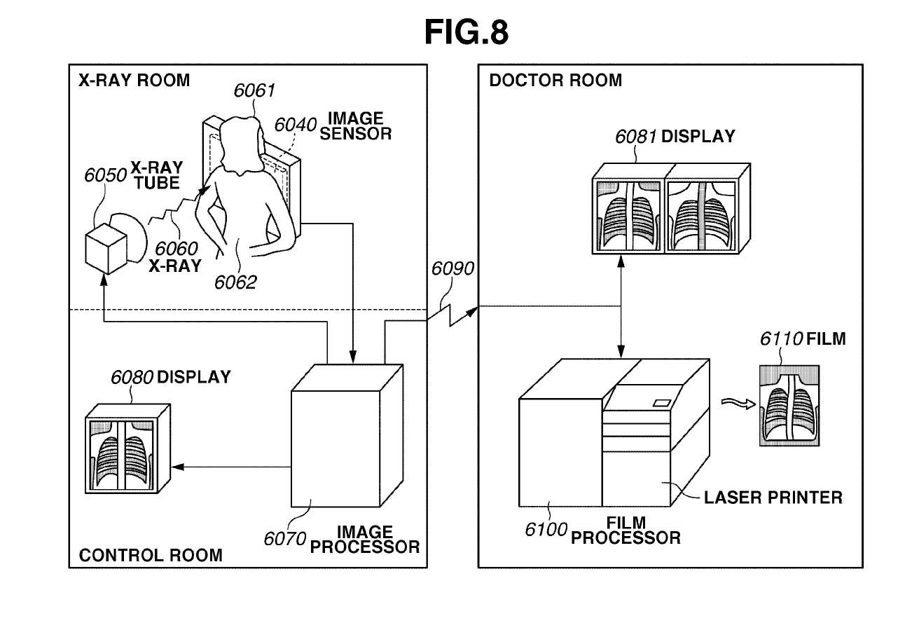

A fourth exemplary embodiment will be described. Next, an example in which the detecting device is applied to a radiation detecting system will be described with reference to FIG. 8. An X-ray 6060 generated by an X-ray tube 6050 which is a radiation source passes through a chest 6062 of a subject or a patient 6061 , and is incident to a detecting device 6040 of the present invention. The incident X-ray includes information of the patient 6061's interior. The scintillator 216 emits light in response to the incident X-ray, and the light is converted into an electric signal by the photoelectric conversion element, and thus electric information is obtained. This information is converted into a digital signal, subjected to image processing by an image processor 6070 which is a signal processing unit, and thus can be observed through a display 6080 which is a display unit of a control room.

Further, this information may be transferred to a remote site through a transmission processing means such as a telephone line 6090, and displayed on a display 6081 which is a display unit in a doctor room at a separated place or the like or stored in a recording unit such as an optical disk, and thus a doctor can make diagnosis at a remote site. Further, the information maybe stored in a film 6110 serving as a recording medium using a film processor 6100 serving as a recording unit.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-009305 filed Jan. 19, 2012, which is hereby incorporated by reference herein in its entirety.

What is claimed is:

1. A matrix substrate comprising:
a plurality of pixels arranged in a matrix of rows and columns;
a plurality of driving lines arranged in parallel in a column direction and connected in common to a plurality of pixels in a row direction;
a plurality of connection terminals that are disposed to be smaller in number than the number of the plurality of driving lines and connect a driving circuit that drives the plurality of pixels with the plurality of driving lines; and
a demultiplexer that includes a plurality of unit circuits and a plurality of control lines and that connects the plurality of connection terminals to the plurality of driving lines,
wherein each unit circuit among the plurality of unit circuits includes a plurality of transistors and connects a predetermined connection terminal among the plurality of connection terminals to two or more predetermined driving lines among the plurality of driving lines, and
wherein the plurality of control lines is connected to control electrodes of the plurality of transistors to supply a conducting voltage and a non-conducting voltage of the plurality of transistors,
wherein the plurality of unit circuits include a predetermined unit circuit and another unit circuit adjacent to the predetermined unit circuit, and
a control terminal of a transistor positioned to be closest to the other unit circuit among the plurality of transistors included in the predetermined unit circuit and a control terminal of a transistor positioned to be closest to the predetermined unit circuit among the plurality of transistors included in the other unit circuit are connected to the same control line among the plurality of control lines.

2. The matrix substrate according to claim 1,
wherein the demultiplexer further includes a first demultiplexer circuit including the transistors each connected to a predetermined connection terminals among the plurality of connection terminals and a second demultiplexer circuit connected to the first demultiplexer circuit and the driving line, and
the second demultiplexer circuit includes a second transistor serially connected with at least one of the plurality of transistors.

3. The matrix substrate according to claim 1,
wherein the transistor is a transistor which supplies the driving line with a first voltage to cause the pixels to be in a selected state, and
wherein the unit circuit further includes a plurality of third transistors that are disposed to correspond to the driving lines on a one-on-one basis and supplies the driving line with a second voltage to cause the pixels to be in a non-selected state.

4. The matrix substrate according to claim 1,
wherein the demultiplexer further includes a plurality of fourth transistors which are disposed in parallel to the plurality of transistors, and
control electrodes of the plurality of fourth transistors are electrically connected in common to a connection terminal to which a conducting voltage of the plurality of fourth transistors is supplied in a pixel addition mode.

5. The matrix substrate according to claim 3,
wherein the pixel includes a switching element that outputs an electric signal according to electric charges generated by a conversion element that converts radiation or light into electric charges, wherein the first voltage is a conducting voltage of the switching element, and wherein the second voltage is a non-conducting voltage of the switching element.

6. The matrix substrate according to claim 5,
wherein the conversion element includes a scintillator that converts radiation into light and a photoelectric conversion element that converts the light into electric charges.

7. A detecting device comprising:
the matrix substrate according to claim 1;
the driving circuit; and
a control circuit that supplies the control line with a conducting voltage and a non-conducting voltage of the transistor,
wherein the control circuit supplies the control line with the conducting voltage and the non-conducting voltage of the transistor with a frequency which is half a frequency at which the plurality of pixels is driven.

8. The detecting device according to claim 7,
wherein the driving circuit includes a plurality of flexible printed circuits which include driving integrated circuits,
a plurality of demultiplexers is disposed to correspond to the driving integrated circuits on a one-on-one basis,
the control line is divided into two or more to correspond to the driving integrated circuits on a one-on-one basis, and
each divided control line is electrically connected with wiring disposed in a corresponding flexible printed circuit among the plurality of flexible printed circuits.

9. A detecting system comprising:
the detecting device according to claim 7;
a signal processing unit that processes a signal from the detecting device;
a recording unit that records a signal from the signal processing unit;
a display unit that displays a signal from the signal processing unit; and
a transmission processing unit that transmits a signal from the signal processing unit.

10. A detecting device comprising:
a plurality of pixels arranged in a matrix of rows and columns;
a plurality of driving lines that are arranged in parallel in a column direction and connected in common to a plurality of pixels in a row direction;
a driving circuit that drives the plurality of pixels;
a plurality of connection terminals that are disposed to be smaller in number than the number of the plurality of driving lines and connect the driving circuit with the plurality of driving lines;
a demultiplexer that includes a plurality of unit circuits and a plurality of control lines and connects the plurality of connection terminals to the plurality of driving lines,
wherein each unit circuit among the plurality of unit circuits includes a plurality of transistors that connect a predetermined connection terminal among the plurality of connection terminals with two or more predetermined driving lines among the plurality of driving lines, and
wherein the plurality of control lines is connected to control electrodes of the plurality of transistors to supply a conducting voltage and a non-conducting voltage of the transistor; and
a control circuit that supplies the control line with the conducting voltage and the non-conducting voltage of the transistor,
wherein the control circuit supplies the control line with the conducting voltage and the non-conducting voltage of the transistor at a frequency which is half a frequency at which the pixel is driven.

11. The detecting device according to claim 10,
wherein the driving circuit includes a plurality of flexible printed circuits which include driving integrated circuits,
a plurality of demultiplexers is disposed to correspond to the driving integrated circuits on a one-on-one basis,
the control line is divided into two or more to correspond to the driving integrated circuits on a one-on-one basis, and
each divided control line is electrically connected with an wiring disposed in a corresponding flexible printed circuit among the plurality of flexible printed circuits.

12. A detecting system comprising:
the detecting device according to claim 10;
a signal processing unit that processes a signal from the detecting device;
a recording unit that records a signal from the signal processing unit;
a display unit that displays a signal from the signal processing unit; and
a transmission processing unit that transmits a signal from the signal processing unit.
